(19) United States
(12) Patent Application Publication
(10) Pub. No.: US 2011/0298743 A1
(43) Pub. Date: Dec. 8, 2011

(54) INFORMATION PROCESSING APPARATUS

(75) Inventors: Satoshi MACHIDA, Kawasaki-shi (JP); Sachiko ABE, Kawasaki-shi (JP); Yukio KAGAMI, Tokyo (JP); Mitsuhiro SATOU, Tokyo (JP); Kenichi NAKAMURA, Kawasaki-shi (JP); Kanji CHUJO, Kawasaki-shi (JP); Ayako HOSOI, Kawasaki-shi (JP); Akemi TOYOKURA, Kawasaki-shi (JP)

(73) Assignee: FUJITSU TOSHIBA MOBILE COMMUNICATIONS LIMITED, Kawasaki-shi (JP)

(21) Appl. No.: 13/208,996

(22) Filed: Aug. 12, 2011

Related U.S. Application Data
(63) Continuation of application No. PCT/JP2010/051992, filed on Feb. 10, 2010.

(30) Foreign Application Priority Data
Feb. 13, 2009 (JP) 2009-031792

(51) Int. Cl. G06F 3/041

(52) U.S. Cl. 345/173

(57) ABSTRACT

An information processing apparatus includes a touch panel configured to provide a display and detect an operation on the display; and a display control part configured to cause a second operation pad to be displayed, in place of a first operation pad, in the touch panel when the touch panel that selectively displays the first operation pad having a first switching button or the second operation pad having a second switching button detects an operation on the first switching button, and cause the first operation pad to be displayed in place of the second operation pad when the touch panel detects an operation on the second switching button.

### CROSS REFERENCE TO RELATED APPLICATIONS

This application is a continuation application filed under 35 U.S.C. 111(a) claiming benefit under 35 U.S.C. 120 and 365(c) of PCT International Application No. PCT/JP2010/051992 filed on Feb. 10, 2010, the entire contents of which are incorporated herein by references.

### FIELD

The disclosures herein relate to an information processing apparatus, including processing of input operations by touch.

### BACKGROUND

An information processing apparatus is known that displays an input area in a touch panel to allow a user to touch the area with his/her finger or a stylus pen and performs predetermined operations to move the position of a cursor displayed on the touch panel according to movement of the finger or the stylus pen in contact with the touch panel. (See, for example, Patent Document 1 listed below).

A touch panel includes a display and a pressure sensitive or capacitive touch pad fixed to the front face of the display. The display is an arbitrary type of display device such as an LCD (liquid crystal display) or an organic electroluminescence display. The touch pad detects a touch event created by a finger or a stylus pen, or an event that the finger or the stylus pen has comes within a predetermined distance.

Input operations through a touch panel are conducted in portable devices such as mobile communicating devices, smartphones, or portable game consoles. In general, a user holds a portable device with a touch panel in one hand and a stylus pen in the other hand to manipulate the touch panel using the stylus pen or a finger (first finger, for example). Thus, it is envisioned that input manipulations are conducted on a portable device with a touch panel using both hands.

### PRIOR ART DOCUMENT

Patent Document 1: Japanese Laid-Open Patent Publication No. H06-150176 (Page 1, FIG. 2 and FIG. 4)

However, in the method disclosed in Patent Document 1, consideration is not sufficiently made of user-friendliness of input operations through a touch panel of a portable device. This issue becomes conspicuous under the situation where, for example, a user is hanging on a strap in a train with one hand free.

It is desirable for a user to hold a portable device in a hand and easily manipulate it with a finger (a thumb, for example) of the same hand. However, it has been implicitly envisioned for a conventional portable device that both hands are used to manipulate the device. The first reason is that a small input area size is not contemplated. With a large input area on a portable device, one-hand manipulation is not possible.

The second reason is that software keys such as icons or operation keys are displayed in the small images on the touch panel. Input operations are generally carried out by touching the software keys on a touch screen type portable device. Since the software keys are small, a stylus pen is required. It is impossible for a user to hold a device and make input operations using a stylus pen with the same hand.

Therefore, it is appropriate to realize an information processing apparatus that allows a user to easily make input operations with one hand.

### SUMMARY

According to one aspect of the present disclosure, an information processing apparatus includes a touch panel configured to provide a display and detect an operation on the display; and a display control part configured to cause a second operation pad to be displayed, in place of a first operation pad, in the touch panel when the touch panel that selectively displays the first operation pad having a first switching button or the second operation pad having a second switching button detects an operation on the first switching button, and cause the first operation pad to be displayed in place of the second operation pad when the touch panel detects an operation on the second switching button.

The object and advantages of the invention will be realized and attained by means of the elements and combinations particularly pointed out in the claims.

It is to be understood that both the foregoing general description and the following detailed description are exemplary and explanatory and are not restrictive to the invention, as claimed.

### BRIEF DESCRIPTION OF DRAWINGS

FIG. 1 is an external view of a mobile telecommunication device according to the first embodiment of the disclosures;

FIG. 2 is a block diagram illustrating a structure of the mobile telecommunication device illustrated in FIG. 1;

FIG. 3 is a flowchart illustrating operations of the touch pad control part illustrated in FIG. 2;

FIG. 4 illustrates a manipulation for activating an operation pad with respect to the touch pad control part illustrated in FIG. 2;

FIG. 5 is a flowchart illustrating operations of the operation pad/pointer control part illustrated in FIG. 2 to cause the operation pad to be displayed;

FIG. 6 illustrates an operation pad displayed on the LCD illustrated in FIG. 2;

FIG. 7 illustrates an iconized operation pad displayed on the LCD illustrated in FIG. 2;

FIG. 8 is a flowchart illustrating operations of the operation pad/pointer control part illustrated in FIG. 2;

FIG. 9 is a flowchart illustrating operations of the display control part illustrated in FIG. 2;

FIG. 10 illustrates an example of a composite image created by the display control part illustrated in FIG. 2;

FIG. 11 illustrates an example of manipulation through the operation pad illustrated in FIG. 2 to move the cursor;

FIG. 12 illustrates an example of manipulation through the operation pad illustrated in FIG. 2 to move the operation pad;

FIG. 13 illustrates an example of manipulation through the operation pad illustrated in FIG. 2 to transmit a tap event;

FIG. 14A is an example of manipulation through the operation pad illustrated in FIG. 2 to iconize the operation pad;

FIG. 14B is an example of manipulation through the operation pad illustrated in FIG. 2 to iconize the operation pad;

FIG. 15 is an example of manipulation through the operation pad illustrated in FIG. 2 to close the operation pad;

FIG. 16 illustrates an operation pad according to the second embodiment of the disclosures;

FIG. 17 is a flowchart illustrating operations of the operation pad/pointer control part according to the second embodiment of the disclosures;

FIG. 18 is a flowchart illustrating operations of the operation pad/pointer control part according to the second embodiment of the disclosures;

FIG. 19 illustrates an example of a composite image created by the display control part according to the second embodiment of the disclosures;

FIG. 20A illustrates an operation pad according to the third embodiment of the disclosures;

FIG. 20B illustrates an operation pad according to the third embodiment of the disclosures;

FIG. 20C illustrates an operation pad according to the third embodiment of the disclosures;

FIG. 21 is a flowchart illustrating operations of the operation pad/pointer control part according to the third embodiment of the disclosures;

FIG. 22 is a flowchart illustrating operations of the operation pad/pointer control part according to the third embodiment of the disclosures;

FIG. 23 illustrates an example of a composite image created by the display control part according to the third embodiment of the disclosures;

FIG. 24 illustrates an example of a composite image created by the display control part according to the third embodiment of the disclosures;

FIG. 25 illustrates an example of a composite image created by the display control part according to the third embodiment of the disclosures;

FIG. 26A illustrates a modification of the operation pad according to the third embodiment of the disclosures;

FIG. 26B illustrates a modification of the operation pad according to the third embodiment of the disclosures;

FIG. 26C illustrates a modification of the operation pad according to the third embodiment of the disclosures; and

FIG. 27 illustrates a display example of the operation pad in the test mode according to the embodiment of the disclosures.

### DESCRIPTION OF EMBODIMENTS

The embodiments of an information processing apparatus are now described with reference to accompanying drawings.

### [a] First Embodiment

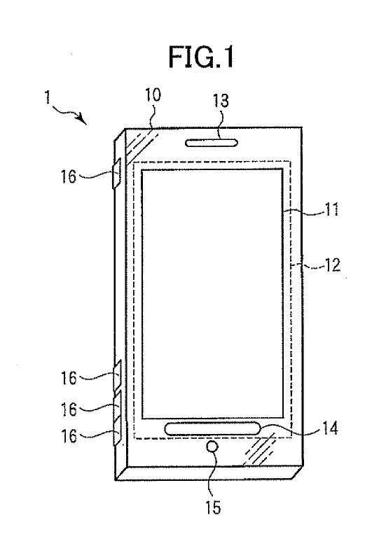

FIG. 1 is an appearance diagram from an anterior view of a mobile communication apparatus 1 to which an information processing apparatus of the first embodiment is applied. A housing 10 of the mobile communication apparatus 1 has a rectangular and plate-like shape.

The front face of the housing is furnished with an LCD 11 for displaying characters, images or the like, a touch pad 12, a speaker 13 for outputting voice and sound, an operation area 14, and a microphone 15 for inputting voice and sound. The touch pad 12 is made of substantially a transparent material and detects coordinates on which a finger or a stylus pen (referred to as a “finger or the like”) touches. The touch pad 12 covers the display screen of the LCD 11, a part of the touch pad 12 runs off the edge of the display screen and covers a portion of the housing 10. The touch pad 12 and the LCD 11 form a so-called touch panel. The touch pad 12 may include a first touch pad provided so as to cover the display screen of the LCD 11 and a second touch pad provided so as to cover a portion of the housing 10 nearby the display screen of the LCD 11. The two touch pads are controlled as a single unit.

The touch pad 12 detects a touch when a finger or the like is in contact with the touch pad over a predetermined period of time. The detection means of the touch pad 12 may be of a pressure sensitive type for detecting a change in pressure on the touch pad 12, of a capacitive type for detecting a change in electrostatic capacitance between the touch pad 12 and the finger or the like in the close vicinity of the touch pad 12, or of any other type. For example, infrared light emitting devices and illuminance sensors are set in a matrix among light emitting elements of the LCD 11 to detect at an illuminace sensor infrared light emitted from the infrared light emitting devices and reflected from the finger or the like. This method can detect coverage of the finger or the like that has come into contact with the touch panel 12.

The operation area 14 is a part of the touch panel 12 that runs off from the edge of the display screen of the LCD 11 and covers the housing 10. Since the touch pad 12 is substantially transparent, it is difficult for a user to recognize visually the operation area 14 covered with the touch pad 12. So a predetermined figure is provided on a part of the housing 10 that serves as the operation area 14, or on the touch pad 12 covering the operation area 14 to allow the user to recognize the position of the operation area 14. The area in which the figure is provided is hereinafter referred to as the “operation area 14” and explanation is made below.

In the description below, contacting the touch pad 12 is called an “operation”, a “touch”, or a “tap”. A touch on a part of the touch pad 12 covering the display screen of the LCD 11 is simply referred to as a touch on the display screen of the LCD 11. A touch on the touch pad 12 at an area corresponding to the operation area 14 is simply referred to as a touch on the operation area 14. It is arbitrarily adapted whether the touch on the operation area 14 is a touch on the marked area of the predetermined figure, or a touch on the all the area outside the display screen of the LCD 11 and covered with the touch pad 12.

A side face of the housing 10 is furnished with multiple operation keys 16 which are adapted to be pressed by a user. Examples of the operation keys 16 of the mobile communication apparatus 1 include a key adapted to input a limited instruction, such as a power ON/OFF key, a phone-call volume control key, or a calling/end-calling key. Character entry software keys are displayed on the LCD 11, and characters can be input by touching the touch pad 12 at a position corresponding to a software key. Many other operations are also performed by a touch on the touch pad 12.

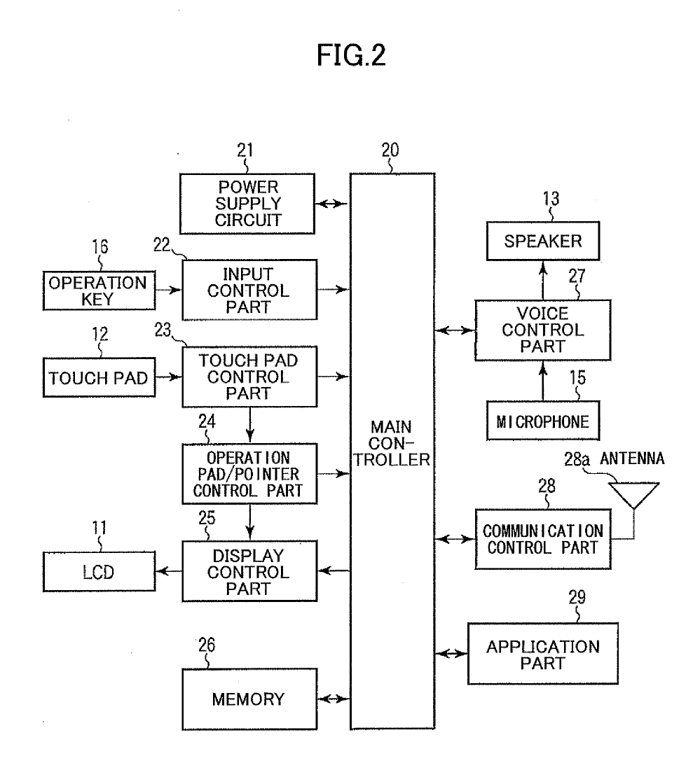

FIG. 2 is a block diagram of the mobile communication apparatus 1 according to an embodiment. The mobile communication apparatus 1 includes a main controller 20, a power supply circuit 21, an input control part 22 connected to the operation keys 16, a touch pad control part 23 connected to the touch pad 12, an operation pad/pointer control part 24, a display control part 25 connected to the LCD 11, a memory 26, a voice control part 27 connected to the speaker 13 and the microphone 15, a communication control part 28 connected to an antenna 28a, and an application part 29, which components are mutually connected via a bus.

The application part 29 is equipped with a function to implement multiple software applications. With this function, the application part 29 serves many functions, such as a tool part, a file system manager, a parameter setting device for setting various parameters of the mobile communication apparatus 1, or a music reproduction device. The tool part is equipped with a set of tools including a call wait processing part to control a call wait process, a launcher menu part to display a launcher menu for selectively launching multiple applications, an e-mail transmitter/receiver part to transmit and receive electronic mails, a web browser to provide a display screen for browsing web sites, and an alarm to report that a prescribed time has come. Arbitrary types of application software may be applied to the invention without any problems, and therefore explanation for individual application software is omitted here.

Explanation is now made of the operations of each part of the mobile communication apparatus 1 with reference to FIG. 2. The main controller 20 includes a CPU (central processing unit) and an OS (operating system). Under the operations of the CPU based upon the OS, the main controller 20 comprehensively controls each part of the mobile communication apparatus 1 and carries out various arithmetic processing and control operations. The CPU may be used by one or more parts other than the main controller 20.

The power supply circuit 21 has a power source such as a battery, and turns on and off the power source of the mobile communication apparatus 1 in response to an ON/OFF operation of the operation key 16. If the power source is turned on, electric power is supplied from the power supply source to the respective parts to make the mobile communication apparatus 1 operable.

Upon detection of a depression of the operation key 16, the input control part 22 generates an identification signal for identifying the manipulated operation key 16, and transmits the identification signal to the main controller 20. The main controller 20 controls the respective parts according to the identification signal.

Upon detection of an operation (such as a touch) on the touch pad 12, the touch pad control part 23 activates or deactivates the operation pad/pointer control part 24. The touch pad control part 23 detects the operated position, generates a signal indicating the operated position, and outputs the signal as a touch pad operating event to the operation pad/pointer control part 24 or the main controller 20. The touch pad operating event includes information about the coordinates of the touched position or information indicating a set of coordinates of multiple positions having been touched in time series.

The operation pad/pointer control part 24 causes the LCD 11 to display an image of the operation pad and an image of the cursor. When the display screen of the LCD 11 is touched by a finger or the like at a position where the operation pad is displayed or when the finger or the like is dragged on the display screen, a touch pad operating event is supplied from the touch pad control part 23 to the operation pad/pointer control part 24. Based upon the touch pad operating event, the operation pad/pointer part 24 provides a display for moving the cursor, or detects an absence of a predetermined operation and reports the absence of detection to the main controller 20.

The display control part 25 combines an image requested by the main controller 20 and an image requested by the operation pad/pointer control part 25 to generate a composite image, and displays the composite image on the LCD 11.

The memory 26 includes a nonvolatile memory such as a ROM (read only memory) for storing a program to execute processes for causing the main controller 20 and the respective parts to operate, and a RAM (random access memory) for temporarily storing data used when the main controller 20 and the respective parts carry on processing. A portion of information in the memory 26 is stored as a file system which includes hierarchical multiple folders and files associated with the folders. The file system is managed by the file system manger.

Voice control part 27 is controlled by the main controller 20. The voice control part 27 generates analog voice/sound signals from voice or sound collected by the microphone 15 and converts the analog voice/sound signals to digital voice/sound signals. When digital voice/sound signals are supplied, the voice control part 27 converts the digital voice/sound signals to analog voice/sound signals, and outputs amplified analog voice/sound signals from the speaker 13 under the control of the main controller 20.

The communication control part 28 is controlled by the main controller 20. The communication control part 28 receives signals transmitted from a base station in a mobile communication network (not shown) via the antenna 28a, and despreads the spread-spectrum of the received signal to restore the data. The data are supplied to the voice control part 27 and the application part 29 according to the instruction from the main controller 20. When supplied to the voice control part 27, the data are subjected to the above-described signal processing and output from the speaker 13. When supplied to the application part 29, the data are further supplied to the display control part 25. In the latter case, an image is displayed on the LCD based upon the data, or recorded in the memory 26.

The communication control part 28 acquires various data from the application part 29, such as voice/sound data collected by the microphone 15, data generated upon operations on the touch pad 12 or the operation key 16, or data stored in the memory 26. The communication part 28 then carries out spectrum spreading on the acquired data, converts to a radio signal and transmits the radio signal to the base station via the antenna 28a.

Operations of the mobile communication apparatus 1 are explained below. In the following descriptions, explanation is made of operations for inputting instructions easily by one hand with respect to the touch pad control part 23, the operation pad/pointer control part 24 and the display control part 25.

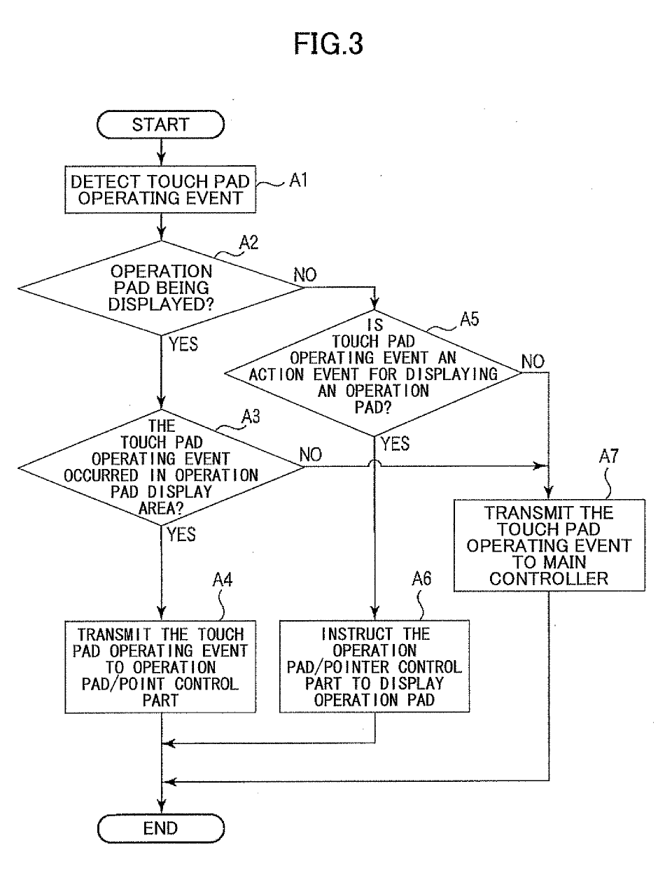

First, with reference to the flowchart of FIG. 3, a process is discussed in which the touch pad control part 23 detects an operation performed on the touch pad 12 and transmits the detected operation to an appropriate control part corresponding to the detected operation. The touch pad control part 23 starts the process illustrated in FIG. 3 at prescribed time intervals or upon occurrence of an interruption due to a manipulation on the touch pad 12. The touch pad control part 23 detects an operation made to the touch pad 12, that is, detects a touch pad operating event (step A1). The touch pad operating event indicates that the touch pad 12 has been manipulated, and contains coordinate information indicating the manipulated position. If, for example, a finger or the like has touched the touch pad 12, the touch pad control part 23 detects the coordinates of the touched position. If the finger or the like is dragged on the touch pad 12, the touch pad control part 23 detects multiple sets of coordinates in time series such that the sequential order of the coordinates of the contacting positions is recognized.

Next, the touch pad control part 23 determines whether the operation pad is being displayed on the LCD 11 (step A2). Since whether or not the operation pad is being displayed on the LCD 11 corresponds to, for example, determination as to whether the operation pad/pointer control part 24 is being activated, this determination is made with reference to task management information of the main controller 20.

If the operation pad is displayed (YES in step A2), the touch pad control part 23 determines whether the touch pad operating event has occurred within the operation pad display area (step A3). The position of the operation pad display area is controlled by the operation pad/pointer control part 24, which position is reported to the main controller 20 and stored in the main controller 20 as a part of resource management information. For this reason, the determination of this step is made with reference to the resource management information.

If the touch pad operating event has occurred in the display area (YES in step A3), the touch pad control part 23 transmits the touch pad operating event to the operation pad/pointer control part 24 (step A4), and then terminates the process.

If the touch pad operating event has occurred outside the display area (NO in step A3), the touch pad control part 23 transmits the touch pad operating event to the main controller 20 (step A7), and then terminates the process. If, on the other hand, the operation pad is not displayed (NO in step A2), it is determined whether the touch pad operating event is an action event for causing the operation pad to be displayed (step A5).

If the operation pad operating event is an action event (YES in step A5), the touch pad control part 23 activates and causes the operation pad/pointer control part 24 to display the operation pad (step A6), and then terminates the process. If the operation pad operating even is an event other than the action event (NO in step A5), then the touch pad control part 23 transmits the touch pad operating event to the main controller 20 (step A7), and terminates the process.

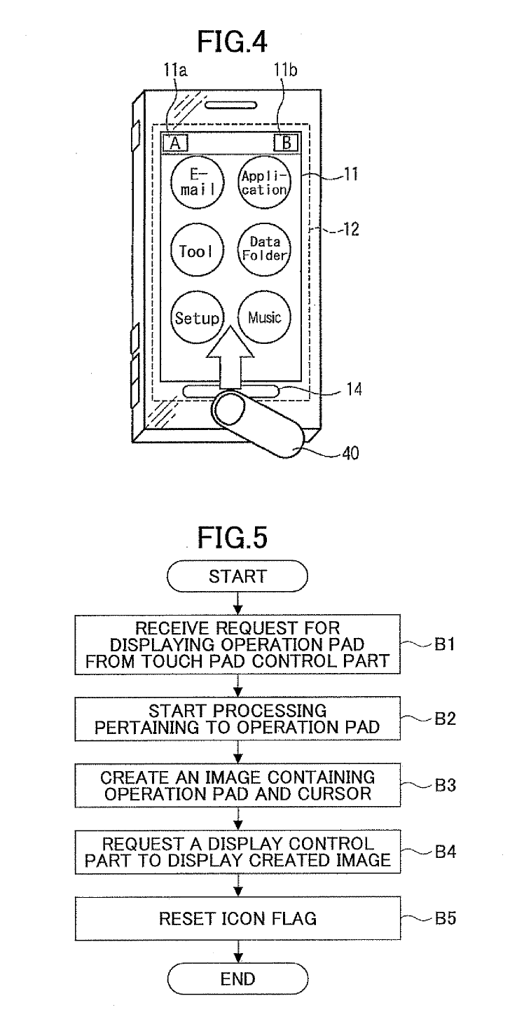

Explanation is made in more detail of the action event for causing the operation pad to be displayed. FIG. 4 illustrates a display screen of the LCD 11 in which an operation pad is not displayed. In this example, a launcher menu part is operating. The displayed image on the LCD 11 in this example is created by the main controller 20. A first specific function indication 11a is displayed at the top left of the display screen, a second specific function indication 11b is displayed at the top right of the display screen, and six icons corresponding to the functions of the launcher menu part are displayed in the rest of the area.

If a touch pad operating event has occurred in any one of the first specific function indication 11a, the second specific function indication 11b and the six icons without the operation pad displayed, that touch pad operating event is transmitted to the main controller 20 as has been explained above in conjunction with the operation of step A7. If the touch pad operating event has occurred from manipulation on the first specific function indication 11a or the second specific function indication 11b, then a common control process independent of the currently running application is performed. Such a common control process includes, for example, termination of the running application, startup of a specific application, or display of the function menu of the main controller 20.

If any one of the six icons has been manipulated, the main controller 20 transmits the touch pad operating event to the running application, namely, the launcher menu part in this example. The launcher menu part starts up the application corresponding to the manipulated icon in accordance to the supplied touch pad operating event.

The action event for displaying the operation pad occurs when a finger 40 comes into contact with the operation area 14 and moves over the LCD 11 while keeping the contact. In other words, if a user puts the finger 40 on the operation area 14 and drags the finger 40 over the LCD 11 while keeping the finger 40 in contact with the touch pad 12, an action event occurs. It is assumed that the mobile communication apparatus 1 is held in his/her right hand of the user and the finger 40 is the right thumb.

Next, FIG. 5 through FIG. 8 are referred to for explaining activation/movement/termination of the operation pad performed by the operation pad/pointer control part 24 and an input operation through the operation pad.

If the operation pad is not displayed when a touch pad operating event has occurred, a process for displaying the operation pad is performed, as has been explained in conjunction with step A6. FIG. 5 illustrates the detailed process for displaying the operation pad. The operation pad/pointer control part 24 starts the process illustrated in FIG. 5 upon a request from the touch pad control part 23.

The operation pad/pointer control part 24 receives a request for displaying the operation pad from the touch pad control part 34 (step B1), and starts processing pertaining to the operation pad (step B2).

Next, the operation pad/pointer control part 24 creates image data containing an operation pad and a cursor image (step B3), and outputs the image data to the display control part 25 to request the display control part 25 to display the image data (step B4). Finally, the operation pad/pointer control part 24 resets an icon flag for indicating whether or not the operation pad is iconized (step B5) and terminates the process. In the reset mode, the icon flag represents that the operation pad is deiconized. When the icon flag is set, the icon flag represents that the operation pad is iconized.

If, on the other hand, the operation pad is displayed in the operation pad display area when a touch pad operating event has occurred, the operation pad/pointer control part 24 receives the touch pad operating event from the touch pad control part 23 and performs a control operation in accordance with the detected touch pad operating event, as has been explained in step A4. In this case, the operation pad/pointer control part 24 performs, for example, display control such as iconization/deiconization of the operation pad, shifting of the cursor display position, shifting of the display position of the operation pad, or termination of displaying the operation pad, as well as reporting the manipulation made to the touch pad 12 to the main controller 20.

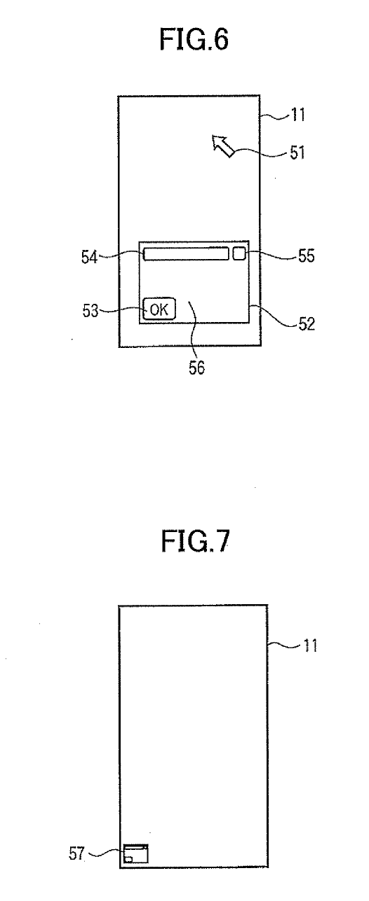

FIG. 6 illustrates a cursor 51 and an operation pad 52 displayed on the LCD 11. The cursor 51 is a pointer to identify a position in the display screen of the LCD 11. The cursor 51 is represented graphically with a shape of arrow; however, the graphic of the pointer is not limited to the arrow. The operation pad 52 is a graphic image with a tap event transmission button 53, an operation pad moving area 54, and an iconization button 55. The rest of the area is a cursor operating area 56.

When the tap event transmission button 53 is manipulated (tapped) by a finger 40, a tap event transmission event is generated by the touch pad control part 23, which event is output to the main controller 20. A tap event transmission event indicates that a position indicated by the cursor 51 has been selected independently of the operation pad 52. Thus, the tap event transmission button 53 can generate an event that has the same effect as tapping at the position indicated by the cursor 51.

In response to this event, the main controller 20 may start a new application and change the image displayed on the display screen. However, even in such a case, there is no change in the operation pad 52 displayed in the LCD 11 and input through the operation pad 52 is continuously available. The operation pad 52 is a general-purpose input tool independent of applications because it is convenient for the newly activated application to continuously use the operation pad.

When the finger moves, while keeping contact with the surface, to the operation pad moving area 54, the touch pad control part 23 detects this event and generates an operation pad moving event. The operation pad moving area 54 is used to move the display position of the operation pad 52 following the movement of the finger 40.

When the finger 40 moves, while keeping in contact with the operation pad moving area 54, to the operation area 14 (FIG. 4) outside the display screen of the LCD 11, the touch pad control part 23 generates an operation pad finishing event to clear the display image of the operation pad 52. The operation pad finishing event can be generated by the user by touching the operation pad moving area 54 with the finger 40 and dragging the finger 40 to the touch pad 12 outside the LCD 11. During this operation, at least a portion of the operation pad 52 moves outside the LCD 11, and this portion brought outside the LCD 11 is not displayed in the LCD 11.

When the finger 40 touches the iconization button 55, an operation pad iconization event is generated by the touch panel control part 23 to iconize the operation pad 52. When the finger 40 touches the cursor operating area 56, a cursor moving event is generated by the touch pad control part 23, and the display position of the cursor 51 is moved to the left and the right, or up and down following the movement of the finger 40 over the operation pad 52 while keeping contact with the surface.

FIG. 7 illustrates an example of the iconized image of the operation pad 57 displayed on the LCD 11. Since the iconized image of the operation pad 57 is small, manipulation on the button or the area included in the operation pad 57 is not available. Accordingly, the operation pad/pointer control part 24 does not display the cursor 51 as long as the iconized operation pad 57 is displayed. When the finger 40 touches the iconized operation pad 57, the touch pad control part 23 generates an operating event. Upon generation of the operating event, the iconized operation pad 57 is deiconized, and a cursor 51 and the operation pad 52 are displayed.

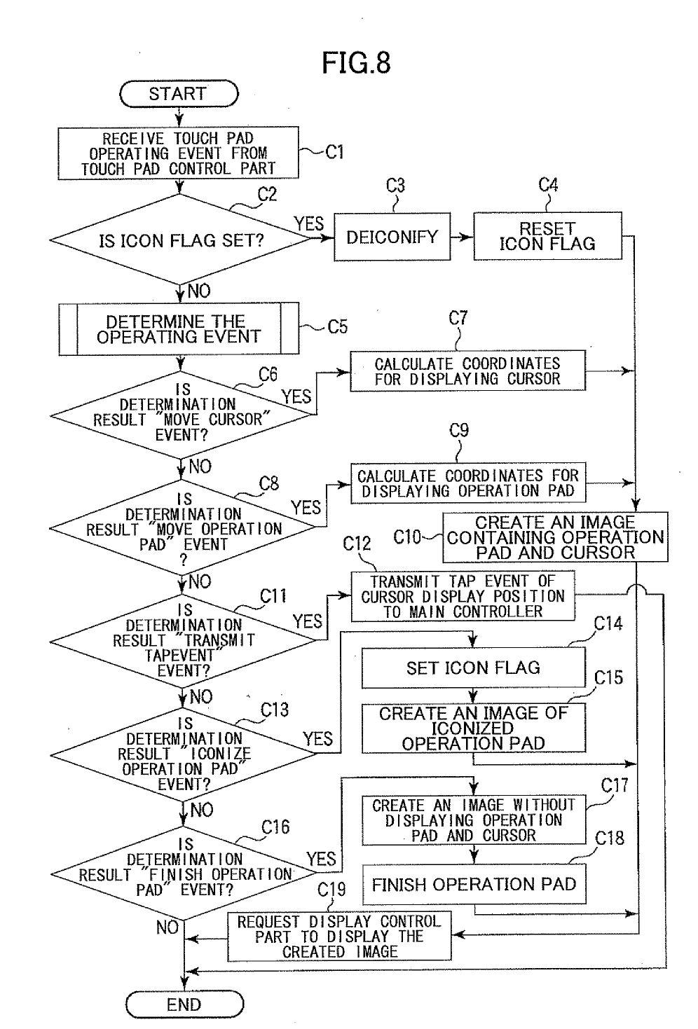

FIG. 8 is a flowchart illustrating operations of the operation pad/pointer control part 24 performed when the operation pad 52 is displayed. Upon receipt of a touch pad operating event from the touch pad control part 23, the operation pad/pointer control part 24 starts the process illustrated in FIG. 8. The operation pad/pointer control part 24 receives a touch pad operating event from the touch pad control part 23 (step C1) and determines whether an icon flag is set (step C2).

If the icon flag is set (YES in step C2), the operation pad/pointer control part 24 switches the display mode to the deiconization state (step C3), and resets the icon flag (step C4). The operation pad/pointer control part 24 creates image data to display an operation pad 52 and a cursor image 51 in place of the iconized operation pad 57 (step C10), and supplies the image data to the display control part 25, requesting for displaying the images of the operation pad 52 and the cursor 51 (step C19). Then the process terminates.

If the icon flag is reset when the touch pad operating event is received (NO in step C2), the operation pad/pointer control part 24 enters determination of the touch pad operating event supplied from the touch pad control part 23 (step C5). In the determination, it is determined whether the touch pad operating event represents a MOVE CURSOR operation, a MOVE OPERATION PAD operation, a TRANSMIT TAP EVENT operation, an ICONIZE OPERATION PAD operation, a FINISH OPERATION PAD operation, or any other types of operation. Actual touch manipulations serving as the determination basis are already explained in conjunction with FIG. 6.

If the determination result represents a MOVE CURSOR operation (YES in step C6), the operation pad/pointer control part 24 calculates display coordinates of a new position of the cursor 51 (step C7), and creates image data containing the operation pad 52 and the cursor 51 in step C10 in order to display the operation pad 52 and the cursor 51 at the calculated positions. The manipulation for moving the cursor 51 is performed by dragging the finger 40 over the cursor operating area 56. As long as the finger 40 is in contact with the cursor operating area 56, steps C7 and C10 are repeatedly performed.

If the determination result represents a MOVE OPERATION PAD operation (YES in step C8), the operation pad/pointer control part 24 calculates coordinates of the new display position of the operation pad 52 based upon the coordinate information contained in the touch pad operating event (step C9), and creates image data containing images of the operation pad 52 and the cursor 51 (step C20) to display the operation pad 52 at the calculated position. The manipulation of moving the operation pad 52 is performed by putting the finger 40 on the operation pad moving area 54 and dragging the finger 40 while keeping contact with the surface. As long as the finger 40 is touching the operation pad moving area 54, steps C9 and C10 are repeatedly performed.

If the determination result represents a TRANSMIT TAP EVENT operation (YES in step C11), the operation pad/pointer control part 24 transmits a tap event including the coordinate information of the display position of the cursor 51 to the main controller 20 (step S12). If the determination result represents a ICONIZE OPERATION PAD operation (YES in step C13), the operation pad/pointer control part 24 sets an icon flag indicating the iconizated state (step C14), and creates image data for displaying the iconzied operation pad 57 in place of the operation pad 52 (step C15). The operation pad/pointer control part 24 supplies the image data to the display control part 25 to request displaying the iconizaed operation pad 57 (step C19) and terminates the process.

If the determination result represents a FINISH OPERATION PAD operation for finishing display of the operation pad (YES in step C16), the operation pad/pointer control part 24 creates image data which does not contain the operation pad 52 nor cursor 51 (step C17) and terminates the input processing through the operation pad (step C18). The operation pad/pointer control part 24 supplies the image data to the display control part 25 to request displaying the image without containing the operation pad 52 and the cursor 51 (step C19). In this manner, the operation pad 52 and the cursor 51 are cleared and the process terminates. If the determination result represents an event other than the above-described operations (NO in step C16), the process terminates without further processing, regarding the operation as an unwanted event.

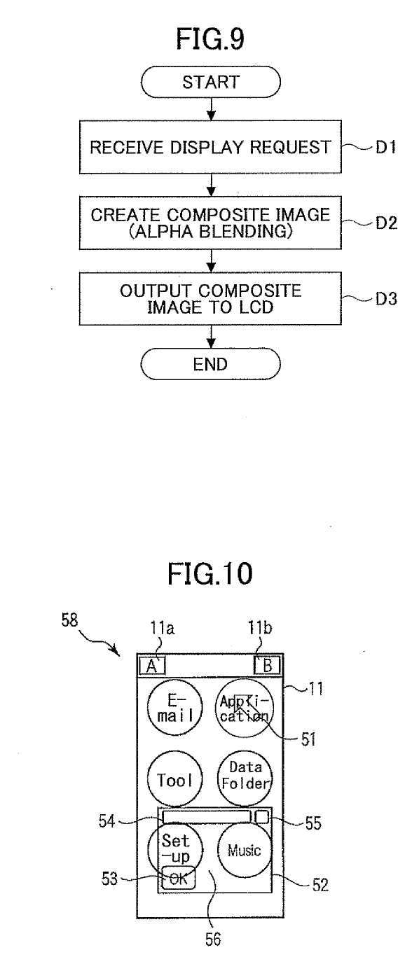

FIG. 9 is a flowchart illustrating operations for displaying a composite image performed by the display control part 25. The display control part 25 combines the image requested by the main controller 20 to display and the image requested by the operation pad/pointer control part 24 to display to display the composite image on the LCD 11.

Upon receiving a request for displaying an image display from the main controller 20 or the operation pad/pointer control part 24, the display control part 25 starts the process illustrated in FIG. 9. The display control part 25 receives the request (step D1), creates a composite image combining the image requested to display by the main controller 20 and the image requested to display by the operation pad/pointer control part 24 (step D2), and displays the composite image on the LCD 11 (step D3). The combination of the images is carried out by, for example, alpha blending.

FIG. 10 illustrates an example of the composite image. The composite image 58 in this figure is created by combining the image illustrated in FIG. 4 which is created by the main controller 20 and the image illustrated in FIG. 6 which is created by the operation pad/pointer control part 24 by alpha blending. The image created by the main controller 20 is visible, and a user interface using the operation pad 52 is provided.

Next, explanation is made of each of the touch manipulations (MOVE CURSOR operation, MOVE OPERATION PAD operation, ICONIZE OPERATION PAD operation, TRANSMIT TAP EVENT operation, and FINISH OPERATION PAD operation).

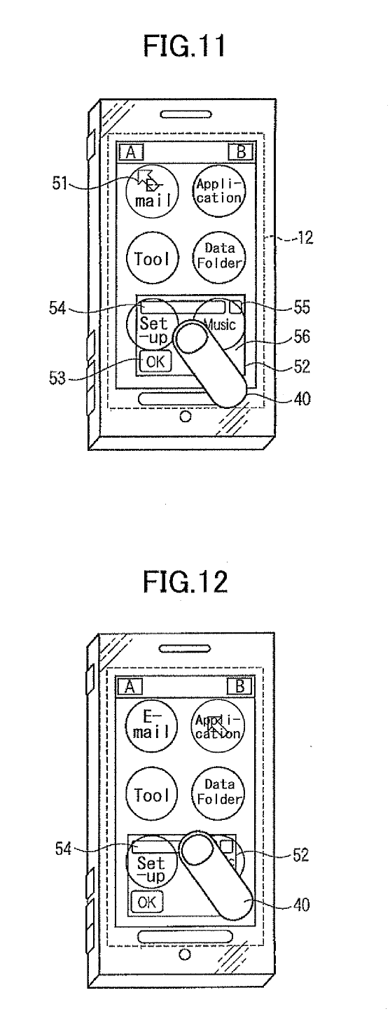

FIG. 11 is a diagram illustrating an operation for moving the cursor 51. When the finger put on the cursor operating area 56 is slid or dragged, the image of the cursor 51 moves under the control of the operation pad/pointer control part 24 and the display control part 25. The cursor operating area 56 is the area other than the tap event transmission button 53, the operation pad moving area 54 and the iconization button 55 in the operation pad 52 (See FIG. 6). For example, in FIG. 11, by sliding the finger 40 to the left, the cursor 51 moves to the left from the position illustrated in FIG. 10. The cursor 51 moves in the same direction as the sliding of the finger 40 over the cursor operating area 56. When a touch pad operating event generated from this manipulation is supplied from the touch pad control part 23, the operation pad/pointer control part 24 determines that a MOVE CURSOR event has occurred in the determination process of step C5 in FIG. 8.

FIG. 12 is a diagram illustrating an operation for moving the operation pad 52. By touching the operation pad moving area 54 in the operation pad with the finger 40 and dragging the finger 40 over the touch pad 12, the displayed image of the operation pad 52 moves under the control of the operation pad/pointer control part 24 and the display control part 25. For example, in FIG. 12, by dragging the finger 40 toward the bottom, the operation pad 52 is moved and displayed below the position illustrated in FIG. 10. The operation pad 52 moves in accordance with the movement of the finger 40. When a touch pad operating generated from this manipulation is supplied from the touch pad control part 23, the operation pad/pointer control part 24 determines that a MOVE OPERATION PAD event has occurred in the determination process of step C5 in FIG. 8.

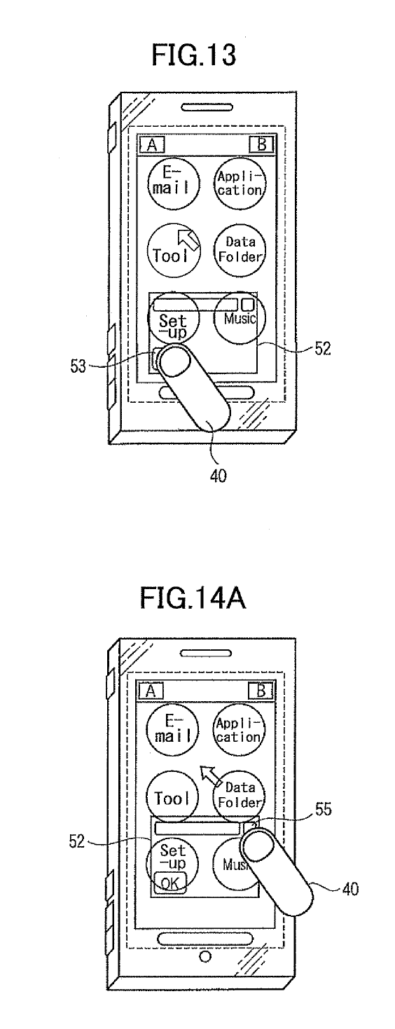

FIG. 13 is a diagram illustrating an operation for transmitting a tap event. By touching (tapping) the tap event transmission button 53 with the finger 40, a touch pad operating event is generated by the touch pad control part 23 in response to this manipulation and supplied to the operation pad/pointer control part 24. The operation pad/pointer control part 24 determines that a TRANSMIT TAP EVENT operation has been done in the determination process of step C5 in FIG. 8. In response to this event, the operation pad/pointer control part 24 transmits an event representing that a position designated by the cursor 51 is tapped to the main controller 20, regardless of the operation pad 52. If an icon is displayed at the position designated by the cursor 51, the main controller 20 activates the tool corresponding to the icon among the tools held in the application part 29.

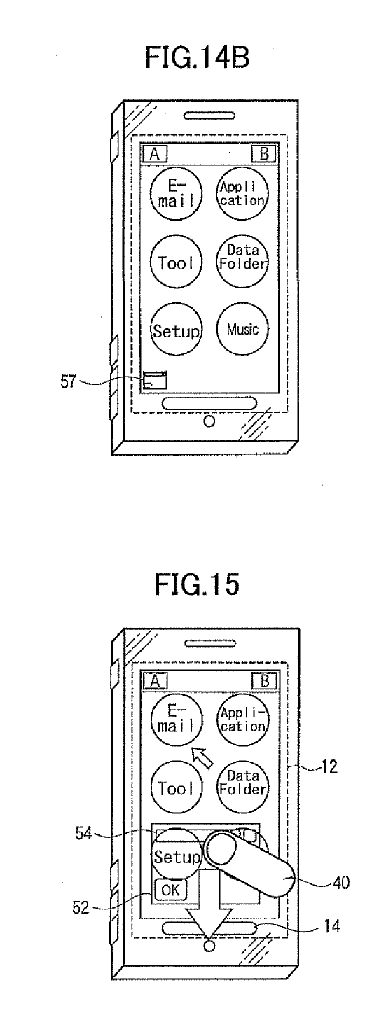

FIG. 14A and FIG. 14B are diagrams illustrating operations for iconizing the operation pad 52. FIG. 14A illustrates a manipulation of tapping the iconization button 55 in the operation pad 52 with the finger 40. By tapping the iconization button 55 by the finger 40, the operation pad 52 is iconized. When a touch pad operating event generated from this manipulation is supplied from the touch pad control part 23, the operation pad/pointer control part 24 determines that a manipulation for iconizing the operation pad 52 has been made in the determination process of step C5 in FIG. 8. FIG. 14B illustrates the display screen in which the iconized operation pad 57 is displayed in place of the operation pad 52. To deiconize the operation pad 57 to display the operation pad 52, the iconized operation pad 57 is simply touched (tapped) with the finger 40.

FIG. 15 is a diagram illustrating a manipulation for terminating the display of the operation pad 52. By touching the operation pad moving area 54 in the operation pad 52 with the finger 40 and dragging the finger 40 over the touch pad 12 to the operation are 14, the display images of the operation pad 52 and the cursor 51 can be cleared. When a touch pad operating event generated from this manipulation is supplied from the touch pad control part 23, the operation pad/pointer control part 24 determines that a manipulation for finishing the display of the operation pad 52 has been made in the determination process of step C5 in FIG. 8.

In other words, if the user touches the operation pad moving area 54 displayed on the LCD 11 with the finger 40 and slides the finger 40 outside the LCD 11 to the operation area 14, display of the operation pad 52 an the cursor 51 can be terminated.

This action is detected by the touch pad control part 23 based upon the detection result of the touch pad 12, and reported as a touch pad operating event to the operation pad/pointer control part 24. The operation pad/pointer control part 24 determines in step C16 that an action for terminating the display of the operation pad 52 has been taken, and accordingly, instructs the display control part 25 to finish the display of the operation pad 52.

The operation pad 52 can be displayed by the inverse manipulation. That is, the user puts the finger 40 on the operation area 14 and slides the finger 40 over the LCD 11. This action is detected by the touch pad control part 23 based upon the detection result of the touch pad 12, and reported as a touch pad operating event to the operation pad/pointer control part 24. The operation pad/pointer control part 24 determines that an action for starting the display of the operation pad has been taken, and instructs the display control part 25 to display the operation pad 52.

### [b] Second Embodiment

A mobile communication apparatus 1 to which an information processing apparatus according to the second embodiment is applied is now described. The mobile communication apparatus 1 of this embodiment has a superficially similar structure as that of the first embodiment illustrated in FIG. 1 and FIG. 2. The same components as those of the mobile communication apparatus 1 of the first embodiment are denoted by the same numerical symbols and detailed explanation for these components are omitted. Descriptions below focus mainly on the points of difference and the structure not specifically explained is the same as that of the mobile communication apparatus 1 of the first embodiment.

The mobile communication apparatus 1 to which the information processing apparatus of the second embodiment is applied partially differs from the mobile communication apparatus 1 of the first embodiment in configuration of the operation pad and operations of the operations pad/pointer control part 24 for processing the user's manipulation through the operation pad.

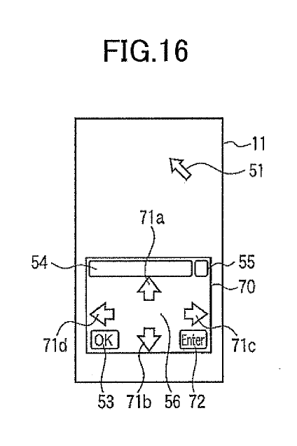

FIG. 16 is a diagram illustrating an operation pad 70 displayed on a mobile communication apparatus of the second embodiment. The operation pad 70 is an image that includes a tap event transmission button 53, an operation pad moving area 54, and an iconization button 55. The image of the operation pad 70 also includes cross-key buttons (an up key button 71a, a down key button 71b, a right key button 71c and a left key button 71d), an enter key button 72 and a cursor operating area 56 which is the rest of the area of the operation pad 70. Although the cross-key buttons are depicted as graphics of arrows in this example, any graphical shapes other than arrows may be used.

The cross-key buttons 71a-71d and the enter-key button 72 are used to select one of the items displayed by the application on the LCD 11 and cause the application to perform actions corresponding to the selected item. The application displays the items and selects one of the items. To allow the user to recognize visibly the selection of the item, the selected item is highlighted on the display screen to distinguish from the other items. The highlight indication is called “focus indication” in the descriptions below.

When the up key button 71a is manipulated, the application selects an item displayed above the selected button. When the down key button 71b is manipulated, the application selects an item displayed below the selected button. When the right key button 71c is manipulated, the application selects an item displayed on the right of the selected button. When the left key button 71d is manipulated, the application selects an item displayed on the left of the selected button. Upon manipulation of the enter-key button 72, the application performs actions corresponding to the selected item (focused-on item).

Various applications can be controlled through input operations using either the combination of the cross-key button and the enter-key button 72 or the combination of the cursor 51 and the tap event transmission button 53 explained in the first embodiment.

For example, input operations through the cross-key button and the enter-key button are suitable for selecting six icons displayed by the launcher menu part because these icons are organized in an array in good order. On the other hand, input operations using the cursor 51 and the tap event transmission button 53 are suitable for selecting an anchor contained in a Web-content and displayed by the browser part because anchors are generally not organized in good order.

These two input methods can be appropriately used depending on applications, displayed contents, preference of the user, etc. The mobile communication apparatus 1 is furnished with both input means such that the user can select a desired input method depending on the situation.

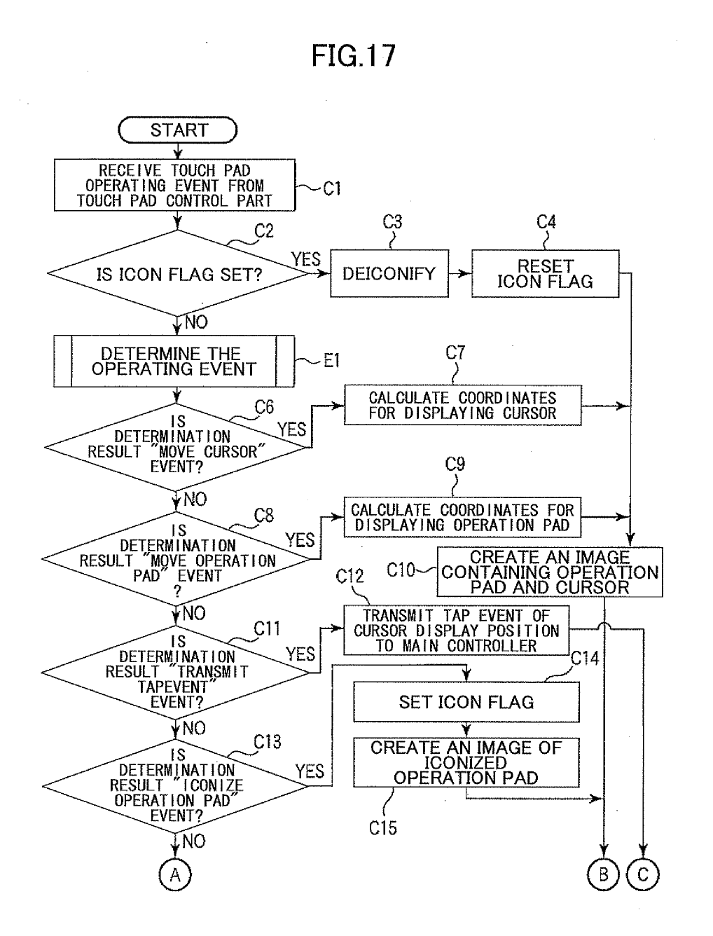

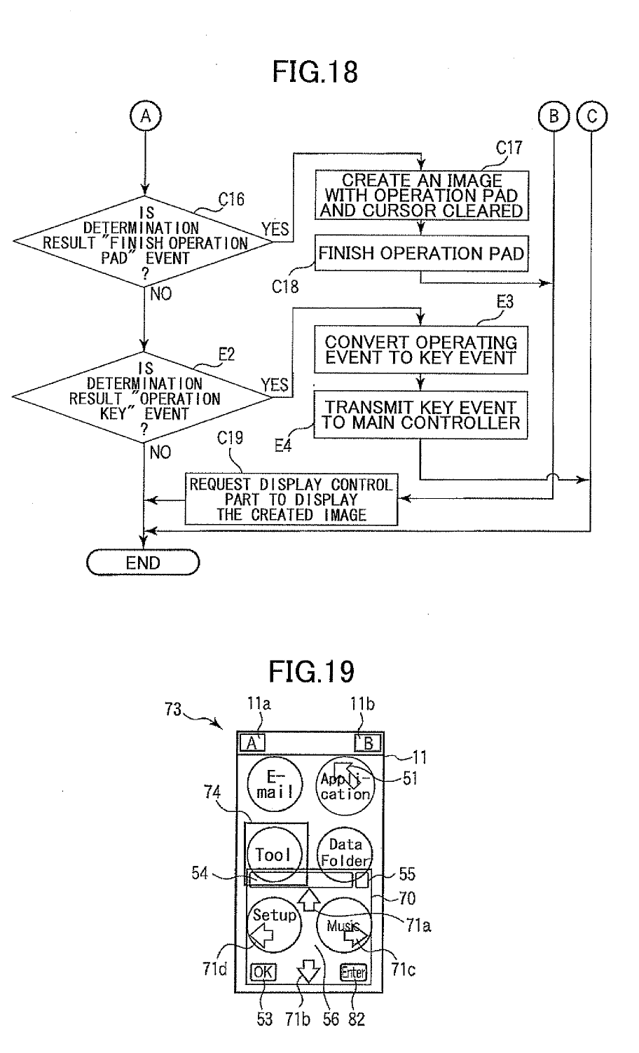

FIG. 17 and FIG. 18 are flowcharts illustrating operations of the operation pad/pointer control part 24 performed when the operation pad 70 is displayed. The same steps as those illustrated in FIG. 8 are denoted by the same symbols and explanation for them is omitted.

The operation pad/pointer control part 24 performs step E1, in place of step C5 of FIG. 8. In step E1, the operation pad/pointer control part 24 makes determination on the touch pad operating event received from the touch pad control part 23. More specifically, the operation pad/pointer control part 24 determines whether the touch pad operating event represents which one of MOVE CURSOR operation, MOVE OPERATION PAD operation, TRANSMIT TAP EVENT operation, ICONIZE OPERATION PAD operation, FINISH OPERATION PAD operation, and manipulation on the operation key. In this example, manipulation on the operation key means manipulation on the cross-key button 71a-71d or manipulation on the enter-key button 72. Determination is made as to which operation has been made based upon the coordinated indicating the manipulated position.

In the second embodiment, if it is determined in step C16 that the touch pad operating event is not a FINISH OPERATION PAD operation, the operation pad/pointer control part 24 proceeds to step E2 to determine whether the determination result represents a manipulation on the operation key. If it is determined that the determination result represents a manipulation on the operation key (YES in step E2), the operation pad/pointer control part 24 generates a key event indicating that the operation key (71 or 72) designated by the coordinate information contained in the touch pad operating event has been manipulated (step E3), and transmits the key event to the main controller 20 (step E4). Then the process terminates. The main controller 20 instructs the display control part 25 to move the display position of the focus indication 74 (FIG. 19) in accordance with the manipulation on the operation key. If the coordinate information agrees with any one of the cross-key buttons 71a-71d, the main controller 20 causes the focus indication to shift to an item on the left, the right, upward, or downward corresponding to the cross-key button.

With reference to FIG. 19, explanation is made of control operations of the display control part 25 for combining an image requested by the main controller 20 to display and an image requested by the operation pad/pointer control part 24 to create and display a composite image on the LCD 11.

The composite image 73 illustrated in FIG. 19 includes an operation pad 70 in place of the operation pad 52, compared to the composite image 58 illustrated in FIG. 10. In addition, a focus indication 74 is formed and incorporated into the composite image 73 by the main controller 20.

The focus indication 74 is a pointer to highlight or emphasize the item selected by the manipulation on the cross-key button so as to distinguish from the other items displayed by the application. In FIG. 19, the focus indication 74 is a rectangular thick frame surrounding the selected item. It should be noted that the first specific function indication 11a and the second specific function indication 11b are not the targets to be highlighted because these indications are independent of the application. The focus indication 74 is not limited to the rectangular frame. An arbitrary color may be set or blinking may be employed for the focus indication 74.

In the foregoing example, the main controller 20 creates the focus indication 74 and control the display position; however, the invention is not limited to this example. For example, the operation pad/pointer control part 24 may perform these functions in place of the main controller 20.

### [c] Third Embodiment

A mobile communication apparatus 1 to which an information processing apparatus according to the third embodiment is applied is similar to the mobile communication apparatus 1 of the first embodiment and the second embodiment. Accordingly, the same components as those of the mobile communication apparatuses 1 of the first and the second embodiments are denoted by the same numerical symbols and only the different points are explained below, avoiding redundant descriptions.

The mobile communication apparatus 1 to which the information processing apparatus of the third embodiment is applied partially differs from the mobile communication apparatuses 1 of the first and the second embodiments in configuration of the operation pad and operations of the operations pad/pointer control part 24 for processing the user's manipulation through the operation pad.

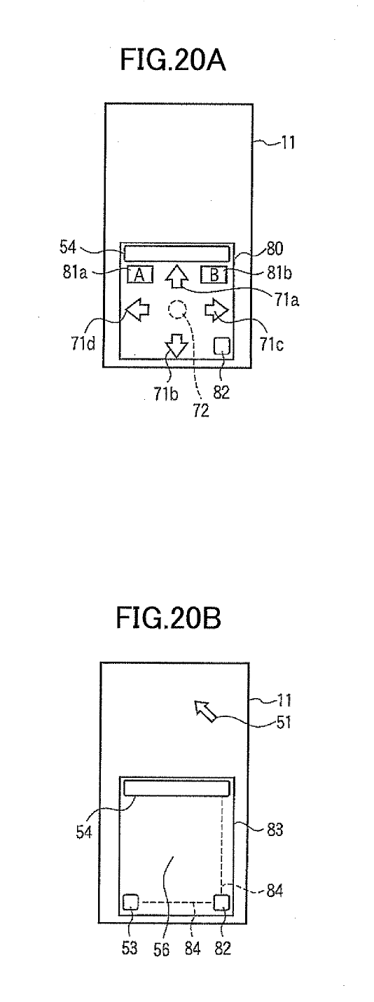

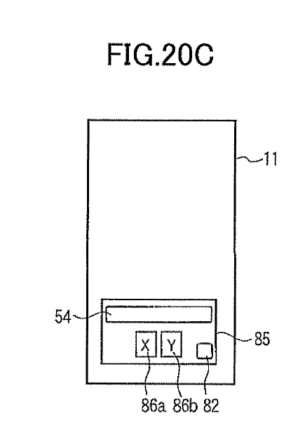

With reference to FIG. 20A, FIG. 20B and FIG. 20C, explanation is made of operation pads used in the mobile communication apparatus 1 according to the third embodiment. In this embodiment, three types of operation pad (the first through third operation pads) are provided and one of these operation pads is selectively displayed. When the displayed operation pad is cleared (non-displayed), another operation pad is newly displayed by a predetermined operation. This newly displayed operation pad is the same type of the operation pad as that has been displayed immediately before the clear operation. Since in this embodiment one of the multiple operation pads prepared in advance is selectively displayed, display control processes on the respective operation pads are simple and clear. There is little likelihood that the user performs wrong operations.

As illustrated in FIG. 20A, the first operation pad 80 is an image in which are displayed an operation pad moving area 54, cross-key buttons (an up key button 71a, a down key button 71b, a right key button 71c and a left key button 71d), an enter key button 72, a first specific function indication 81a, a second specific function indication 81b, and an operation pad switching button 82.

The first specific function indication 81a and the second specific function indication 81b correspond to the first specific function indication 11a and the second specific function indication 11b, respectively, illustrated in FIG. 4. In FIG. 4, the first specific function indication 11a and the second specific function indication 11b are displayed at the top corners of the LCD 11 and excluded from the targets of focus indication 74. However, it is difficult for the user who is using the mobile communication apparatus 1 with one hand to touch the first specific function indication 11a or the second specific function indication 11b with his/her finger 40. The user has to shift the mobile communication apparatus 1 in the hand in order to touch these indications with finger 40. In contrast, the first specific function indication 81a and the second specific function indication 81b of the third embodiment are displayed within the operation pad 80. The user can easily touch these specific function indications 81a and 81b with the finger 40 even if the mobile communication apparatus 1 is held in one hand.

The operation pad switching button 82 is a software key to display a second operation pad, in place of the first operation pad 80, under the control of the main controller 20 when a long press action is taken. Long press is an operation to press or touch continuously over a predetermined time.

During the display of the first operation pad 80, a focus indication 74 (not shown in FIG. 20A) is displayed and the display position is controlled by the main controller 20 as in the operation pad 70 of the second embodiment.

As illustrated in FIG. 20B, the second operation pad 83 includes a tap event transmission button 53, an operation pad moving area 54, an operation pad switching button 82, and a scroll bar 84, and the rest of the area in the second operation pad 83 is a cursor operating area 56. The operation pad switching button 82 is a software key to display a third operation pad, in place of the second operation pad 83, under the control of the main controller 20 when a long press action is taken. The main controller 20 controls such that the cursor 51 is displayed when the second operation pad 83 is displayed.

The scroll bar 84 includes a vertical bar along the right edge of the second operation pad 83, and a horizontal bar along the bottom edge of the second operation pad 83. When the finger 40 is slid along the vertical bar, the displayed image is scrolled by the main controller 20 in the vertical direction. When the finger 40 is slid along the horizontal bar, the displayed image is scrolled by the main controller 20 in the lateral direction.

A long press action is taken to operate the operation pad switching button 82 regardless of the type of displayed operation pad. This is mainly due to the second operation pad 83. In the second operation pad 83, the finger 40 moves broadly over the cursor operating area 56, and therefore, the finger 40 may accidentally touch the operation pad switching button 82. To prevent the operation pad erroneously switched due to the touch, the operation pad switching button 82 is adapted to operate under a long press. Because variation in manipulation on the operation pad switching button 82 among different types of operation pad is not user friendly, long press is employed as a common action.

As illustrated in FIG. 20C, the third operation pad 85 includes an operation pad moving area 54, an operation pad switching button 82, a first function indication 86a, and a second function indication 86b. When the first function indication 86a or the second function indication 86b is manipulated, a prescribed application associated with the function indication is activated. The operation pad switching button 82 is a software key to display the first operation pad 80, in place of the third operation pad 85, under the control of the main controller 20 when a long press action is taken.

The sizes of the first operation pad 80, the second operation pad 83 and the third operation pad 85 may differ from each other. It is desired for the second operation pad 83 to be designed large because it includes the cursor operating area 56. However, since the operation pad is combined with the image created by the main controller 20 on the LCD 11, there may be difficulty in viewing the images due to the operation pad. Accordingly, the operation pad of any type has at most a size touchable by the movement of the finger 40, and it is preferable not to make the size greater than this touchable size.

On the other hand, the third operation pad 85 can be displayed smaller because it does not contain many images. Throughout the first operation pad 80, the second operation pad 83 and the third operation pad 85, the operation pad switching button 82 is displayed at a common position on the display screen of the LCD 11. This arrangement facilitates consecutive switching between the first operation pad 80, the second operation pad 83 and the third operation pad 85.

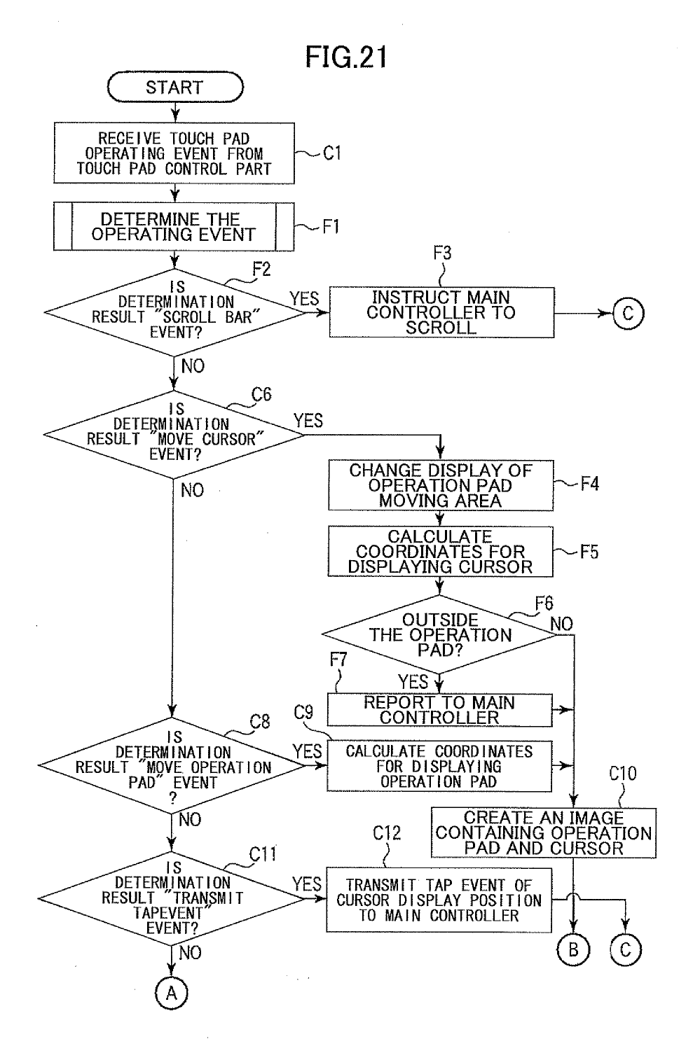

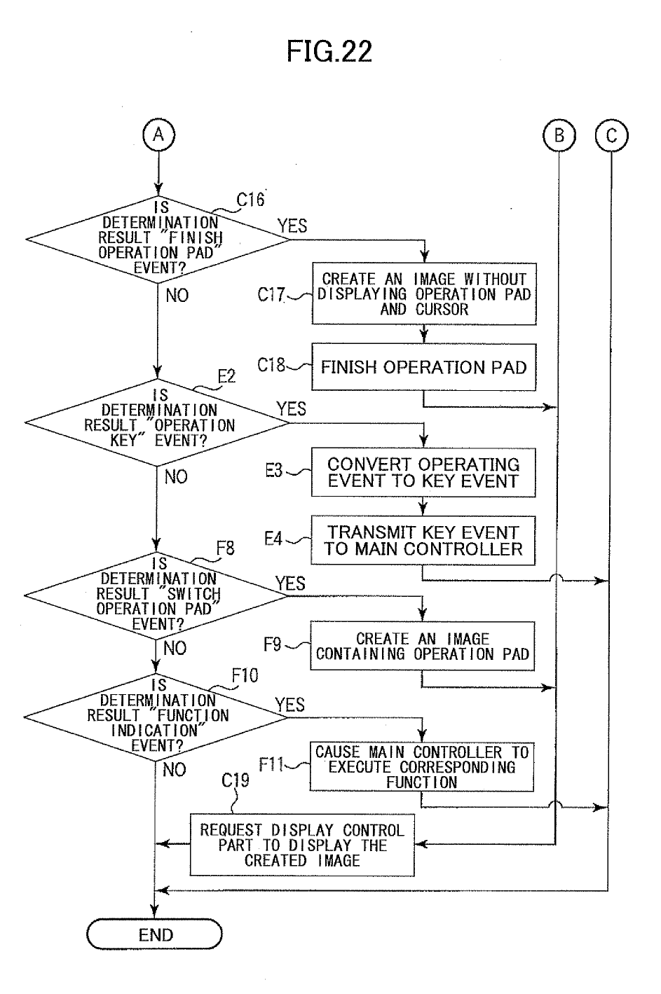

Next, with reference to the flowcharts of FIG. 21 and FIG. 22, operations are described which are performed by the operation pad/pointer control part 24 when the first operation pad 80, the second operation pad 83 or the third operation pad 83 is displayed. The same steps as those in the flowcharts of FIG. 8, FIG. 17 and FIG. 18 are denoted by the same symbols and explanation for them is omitted.

The operation pad of the third embodiment is not iconized. Accordingly, the operation pad/pointer control part 24 does not perform steps C2-C4 for deiconization and steps C13-C15 for iconization in FIG. 8.

The operation pad/pointer control part 24 performs step F1, in place of step C5 of FIG. 8. In step F1, the operation pad/pointer control part 24 makes determination on the touch pad operating event received from the touch pad control part 23. More specifically, the operation pad/pointer control part 24 determines whether the touch pad operating event represents which one of SCROLL BAR operation, MOVE CURSOR operation, MOVE OPERATION PAD operation, TRANSMIT TAP EVENT operation, FINISH OPERATION PAD operation, manipulation on the operation key, SWITCH OPERATION PAD operation, or FUNCTION INDICATION operation for causing the displayed function to be executed. No determination is made as to whether the operation pad is iconized.

SCROLL BAR operation is a manipulation event on the scroll bar 84. SWITCH OPERATION PAD operation is a manipulation event on the operation pad switching button 82. FUNCTION INDICATION operation for causing the displayed function to be executed is a manipulation event on the first specific function indication 81a, the second specific function indication 81b, the first function indication 86a and the second function indication 86b.

If the determination result represents SCROLL BAR operation (YES in step F2; this determination is made only when the second opetaion pad 83 is displayed), the operation pad/pointer control part 24 instructs the main controller 20 to scroll the image displayed on the LCD 11 in the horizontal or vertical direction (step F3), and terminates the process. The main controller 20 controls the display control part 25 such that the image displayed on the LCD 11 is scrolled in the horizontal direction when the horizontal bar is manipulated, and scrolled in the vertical direction when the vertical bar is manipulated.

If the determination result represents MOVE CURSOR operation (YES in step C6; this determination is made only when the second operation pad 83 is displayed), the operation pad/pointer control part 24 performs steps F4-F7, in place of step C7 in FIG. 8.

More specifically, the operation pad/pointer control part 24 instructs the main controller 20 to change the display mode of the operation pad moving area 54 (step F4). The main controller 20 controls the display control part 25 so as to change the display mode. The change in display mode is performed to inform the user of the fact that an operation through the cursor operating area 56 has been made. For example, the color, the color density, and the design may be changed; or alternatively, the display may be blinked. The operation pad/pointer control part 24 calculates the display position of the cursor 51 (step F5) as in step C7.

Then, the operation pad/pointer control part 24 determines whether the position touched by the finger 40 is outside the second operation pad 83 based upon the coordinate information contained in the touch pad operating event (step F6). If the touched positioned is outside the second operation pad 83, namely, if the finger 40 has moved out of the second operation pad 83 while keeping in contact, the operation pad/pointer control part 24 reports this result to the main controller 20 (step F7). The main controller 20 vibrates the vibrator (not shown) to inform the user that the touched position is outside the second operation pad 83 and that the manipulation is invalid. On the other hand, if it is determined that the touched position is not outside the second operation pad 83, the process proceeds to step C10, without reporting, to display a composite image in which the cursor 51 is conflated at the new position.

In step F7, instead of the reporting, the operation pad/pointer control part 24 may move and display the second operation pad 83 following the touching position of the finger 40. In this case, manipulation corresponding to the movement of the finger 40 outside the second operation pad 83 is received, unlike the foregoing. The display positions of the first operation pad 80 and the third operation pad 85 may be shifted according to the movement of the display position of the second operation pad 83. Alternatively, the position of the operation pad switching button 82 may be controlled so as to be displayed at the same position without shifting even if the display positions of the first through third operation pads are changed. These control operations are performed by the main controller 20 and the display control part 25 upon instruction from the operation pad/pointer control part 24 to the main controller 20.

If the determination result is not a manipulation on the operation key (NO in step E2), the operation pad/pointer control part 24 proceeds to step F8. If the determination result represents SWITCH OPERATION PAD operation (YES in step F8), the operation pad/pointer control part 24 creates an image containing a next displayed operation pad in place of the currently displayed operation pad, and outputs the image to the display control part 25 (step F9). Then process proceeds to step C19. The cursor 51 is displayed only when the second operation pad 83 is displayed.

If the determination result represents FUNCTION INDICATION operation for executing the displayed function (YES in step F10; this determination is made only when the first operation pad 80 or the third operation pad 85 is displayed), the operation pad/pointer control part 24 report the manipulated function to the main controller 20. The main controller 20 executes the function corresponding to the reported operation (step F11), and then terminates the process. For example, if the first specific function indication 81a or the second specific function indication 81b has been manipulated, an event signal representing that the first specific function indication 81a or the second specific function indication 81b has occurred is transmitted to the main controller 20. On the other hand, if the first function indication 86a or the second function indication 86b has been manipulated, the main controller 20 is instructed so as to start up the predetermined application associated with the manipulated indication.

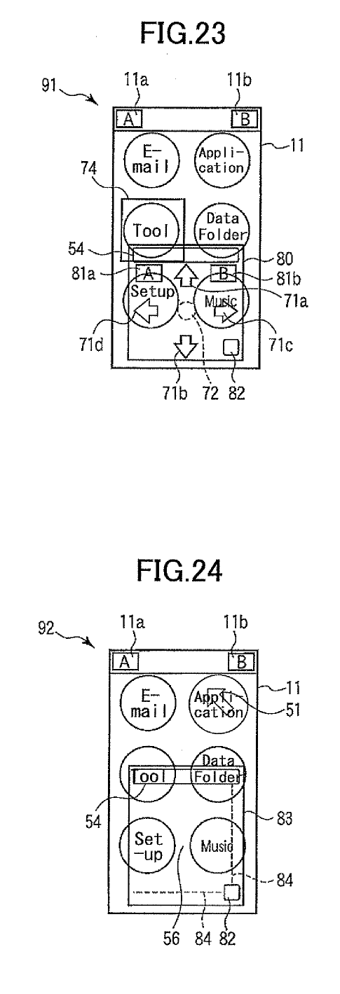

Next, with reference to FIG. 23 through FIG. 25, examples of a composite image created by the display control part 25 are explained. The display control part 25 creates a composite image by combining an image requested to display by the main controller 20 and an image requested to display by the operation pad/pointer control part 24.

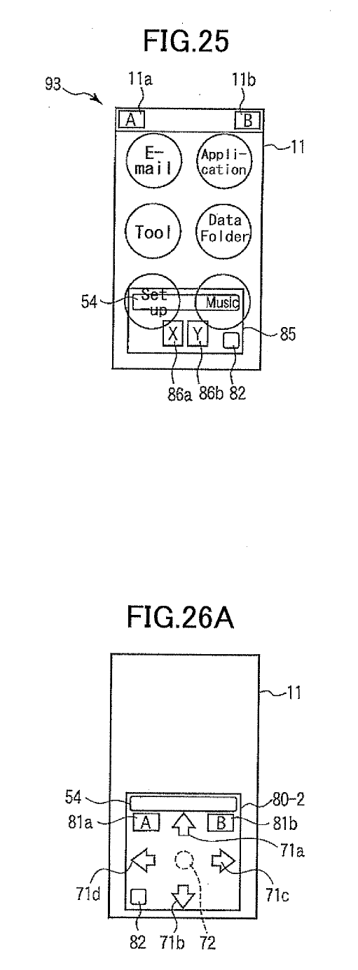

FIG. 23 illustrates a composite image 91 including a first operation pad 80 and a focus indication 74. The focus indication 74 is created by the main controller 20. FIG. 24 illustrates a composite image 92 including a second operation pad 83 and a cursor 51. FIG. 25 illustrates a composite image 93 including a third operation pad 85. The third operation pad 85 is used to promptly activate a selected function which is associated with the first specific function indication 81a or the second specific function indication 81b. The cursor 51 and the focus indication 74 are not displayed.

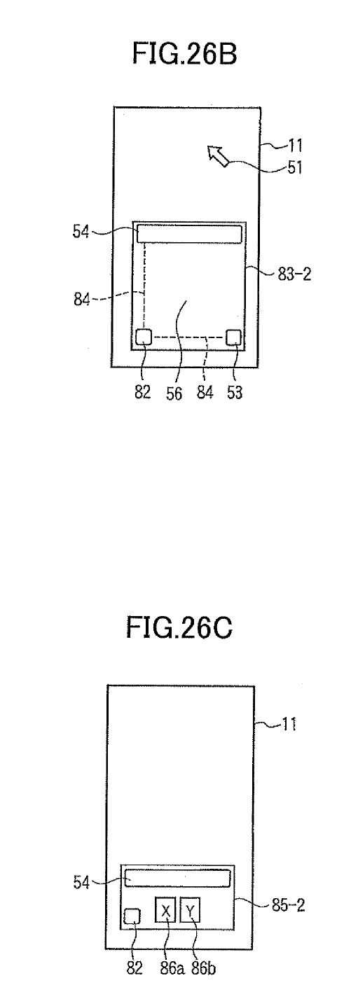

FIG. 26A, FIG. 26B, and FIG. 26C illustrate a first operation pad 80-2, a second operation pad 83-2, and a third operation pad 85-2, respectively, which are modifications of the first operation pad 80, the second operation pad 83, and the third operation pad 85 illustrated in FIG. 20A, FIG. 20B, and FIG. 20C. The position of the operation pad switching button 82 displayed in the first operation pad 80-2, the second operation pad 83-2 and the third operation pad 85-2 is different from that arranged in the first operation pad 80, the second operation pad 83 and the third operation pad 85.

In the first through third operation pads 80, 83 and 85, the operation pad switching button 82 is displayed at the bottom right of the operation pad. On the other hand, in the first through third operation pads 80-2, 83-2 and 85-2, the operation pad switching button 82 is displayed at the bottom left. Along with this change in display position of the operation pad switching button 82, the display positions of the scroll bar 84 and the tap event transmission button 53 have been changed in the second operation pad 83-2, as compared to the second operation pad 83.

Which operation pad group, a group of the first through third operation pads 80, 83 and 85 or a group of the first through third operation pads 80-2, 83-2 and 85-2 is to be used is selected by the user depending on the dominant hand or the taste. Whichever group is selected, an operation pad belonging to the same group is selected for the next display when the display of an operation pad is finished and then an operation pad is displayed again. When the group of the first through third operation pads 80-2, 83-2 and 83-5 is used, the main controller 20 controls the display screen such that the operation pad switching button 82 is displayed at a common position on the LCD 11 among the operation pads.

Although the third embodiment has been described using the example in which three types of operation pads (the first through third operation pads) 80, 83 and 83 are selectively used, the invention is not limited to this example. Any two of these three operation pads may be selectively used.

### [d] Other Embodiments

The operation pad/pointer control part 24 operates in the test mode. The test mode is a mode for checking if the user can easily touch an intended button or area with his/her finger 40 and drag the finger while keeping contact. The test mode is started by the operation pad/pointer control part 24 when, for example, the user first uses the mobile communication apparatus 1 and conducts initial settings, or when the user makes a prescribed manipulation on the operation key 16.

In the test mode, if it is determined that manipulation is not easy for the user, the operation pad/pointer control part 24 increases the size of the operation pad to enlarge the buttons, broaden the intervals between buttons, or increases the input area to improve the operability. Because the optimum values for size, interval or other factors vary depending on the length or the thickness of user's finger, or depending on whether the user touch the display with his/her finger pad or nail, it is desired to appropriately adjust.

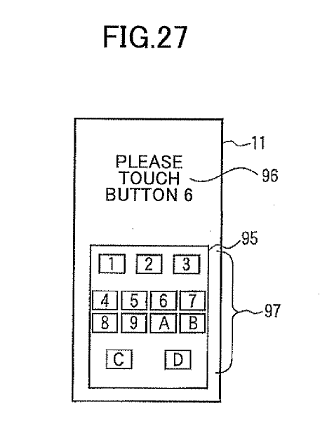

More specifically, in the test mode, the operation pad/pointer control part 24 causes the LCD 11 to display any one of the above-described operation pad or a test-mode dedicated operation pad 95 illustrated in FIG. 27. The operation pad/pointer control part 24 displays a message 96 on the LCD 11, outputs a voice message from the music speaker 95 (not shown) to urge the user to manipulate any one of the test buttons 97 in the operation pad 95. Then the operation pad/pointer control part 24 detects a time to touch (manipulation) and a position touched to determine whether the operation pad is easy to manipulate for the user based upon the detection result. The test button set 97 includes densely arranged buttons and sparsely arranged buttons. By testing using both button arrangements, an appropriate button arrangement can be determined such that the user can easily manipulate.

The aforementioned embodiments may be arbitrarily combined with each other. For example, the second operation pad 83 and the third operation pad 85 of the third embodiment may be furnished with a first specific function indication 81a and a second specific function indication 81b. In the third embodiment, when the finger 40 moves out of the operation pad 83 while keeping contact with the surface, that event is reported or the display position of the second operation pad 83 is shifted. This process may be applied to any operation pads other than the second operation pad 83.

Although the invention has been described using an example applied to a mobile communication apparatus 1, the invention is applicable to other portable information processing apparatuses, such as note-type personal computers, PDAs (personal digital assistants), portable music reproducing apparatuses, television receivers, remote-control devices, etc.

“Portable type” does not necessarily mean cableless connection with other devices. The invention is applicable to, for example, a small input device connected via a signal transmission/reception flexible cable to an arbitrary device or a small device to which power is supplied via a commercially available flexible supply cable.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of superiority or inferiority of the invention. Although the embodiments of the present inventions have been described in detail, it should be understood that the various changes, substitutions, and alterations could be made hereto without departing from the spirit and scope of the invention.

What is claimed is

1. An information processing apparatus comprising:
a touch panel configured to provide a display and detect an operation on a display; and
a display control part configured to cause a second operation pad to be displayed, in place of a first operation pad, in the touch panel when the touch panel that selectively displays the first operation pad having a first switching button or the second operation pad having a second switching button detects an operation on the first switching button, and cause the first operation pad to be displayed in place of the second operation pad when the touch panel detects an operation on the second switching button.

2. The information processing apparatus according to claim 1, wherein the display control part controls a display position of the first operation pad and a display position of the second operation pad to cause the first switching button and the second switching button to be displayed at a same position in the touch panel.

3. The information processing apparatus according to claim 1, wherein the first operation pad includes a software key for receiving an instruction on an operating system and/or application software, and
the second operation pad includes an area for operating a display position of a cursor displayed on the touch panel.

4. The information processing apparatus according to claim 3, wherein the display control part causes one of the first operation pad and the second operation pad to be displayed, in place of the other of the first operation pad and the second operation pad currently being displayed, when the first switching button or the second switching button has been operated for a time exceeding a first threshold value, and causes the software key to receive the instruction when the software key has been touched over a time shorter than the first threshold value and equal to or longer than a second threshold value.

5. The information processing apparatus according to claim 2, wherein the display control part displays the first operation pad so as to be smaller than the second operation pad.

6. The information processing apparatus according to claim 1, further comprising:
a reporting part configured to make a predetermined report when the operation on the second operation pad moves from inside the second operation pad to outside the second operation pad based upon a detection result of the touch panel.

7. An information processing apparatus comprising:
a touch panel having a first area for providing a display and a second area for not providing a display, the touch panel being configured to detect a manipulation on the first area and the second area; and
a display control part configured to cause the touch panel to display an operation pad for receiving a predetermined command when a manipulated position moves from the first area to the second area, based upon a detection result of the touch panel.

8. An information processing apparatus comprising:
a touch panel having a first area for providing a display and a second area for not providing a display, the touch panel being configured to detect a manipulation on the first area and the second area; and
a display control part configured to display an operation pad for receiving a predetermined command on the touch panel and finish displaying the operation pad when a manipulated position moves from the operation pad in the first area to the second area.
